(19) United States
(12) Patent Application Publication
(10) Pub. No.: US 2008/0231592 A1
(43) Pub. Date: Sep. 25, 2008

(54) Electrophoretic Display Device

(75) Inventors: Mark Thomas Johnson, Eindhoven (NL); Neculai Ailenei, Heerlen (NL); Guofu Zhou, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONIC, N.V., EINDHOVEN (NL)

(21) Appl. No.: 10/597,242

(22) PCT Filed: Jan. 12, 2005
(86) PCT No.: PCT/IB05/50132

§ 371 Date: Jul. 18, 2006

(30) Foreign Application Priority Data
Jan. 22, 2004 (EP) 04100217.1

(51) Int. Cl. G09G 3/34

(52) U.S. Cl. 345/107

(57) ABSTRACT

A display device (1) comprises electrophoretic particles (8,9) and an image screen comprising an array of display elements comprising a pixel electrode and a second electrode. The display device comprises control means (15) for supplying drive signals to the electrodes. In operation the image is displayed in subsequent frames. The control means comprise a row driver (16) and a column driver (10). Preset signals (53) are in operation supplied to the display elements whereby the preset signals applied to display elements alter between subsequent frames. The control means are arranged to change preset-signals between frames in a column-to-column scheme. The means for supplying preset signals are arranged such that for the preset signals to at least a part of the image screen comprising a group of columns and rows only one set of data is transferred for the preset signals for said group.

The invention relates to a display device comprising electrophoretic particles, an image screen comprising an array of display elements comprising a pixel electrode and a second electrode between which a portion of the electrophoretic particles are present, and control means for supplying drive signals to the electrodes to bring display elements in a predetermined optical state corresponding to the image information to be displayed, wherein in operation the image is displayed in subsequent frames, said control means comprising a row driver and a column driver, and means for supplying preset signals to the display elements whereby the preset signals applied to display elements alter between subsequent frames.

Display devices of this type are used in, for example, monitors, laptop computers, personal digital assistants (PDA's), mobile telephones, electronic books, electronic newspapers, electronic magazines.

A display device of the type mentioned in the opening paragraph is known from the international patent application WO 03/79324. This patent application discloses a electronic ink display comprising two substrates, one of which is transparent, the other substrate is provided with electrodes arranged in row and columns. A crossing between a row and a column electrode is associated with a display element. The display element is coupled to the column electrode via a thin film transistor (TFT), the gate of which is coupled to the row electrode. This arrangements of display elements, TFT transistors and row and column electrode together forms an active matrix. Furthermore, the display element comprises a picture electrode, also known as a pixel electrode. A select driver, generally referred to as a row driver, selects a row of display elements and the data driver, generally referred to as a column driver, supplies a data signal to the selected row of display elements via the column electrodes and the TFT transistors. The data signals correspond to graphic data to be displayed. The image information, at least part of it, is updated and refreshed at the transition from one frame to another.

An electronic ink is provided between the pixel electrode and a common electrode provided on the transparent substrate. The ink comprises positively charged white particles and negative charge black particles suspended in a fluid. When a positive field is applied to the picture electrode, the white particles move to the side of the micro capsule directed to the transparent substrate and the display element become visible to a viewer. Simultaneously, the black particles move to the pixel electrode at the opposite side of the microcapsule where they are hidden to the viewer. By applying a negative field to the picture electrode, the black particles move to the common electrode at the side of the micro capsule directed to the transparent substrate and the display element appears dark to a viewer. When the electric field is removed the display device remains in the acquired state and exhibit a bi-stable character.

Grey scales can be created in the display device by controlling the amount of particles that move to counter electrode at the top of the microcapsules. For example, the energy of the positive or negative electric field, defined as the product of field strength and time of application, controls the amount of particles moving to the top of the microcapsules.

The optical response depends on the history of the display element and a so-called underdrive effect is seen. This underdrive effect occurs, for example, when an initial state of the display device is black and the display is periodically switched between the white and the black state. For example, after a dwell time of several seconds, the display device is switched to white by applying a negative field for an interval of 200 ms. In a subsequent interval, no electric field is applied for 200 ms and the display, remains white, and in a subsequent interval, a positive field is applied for 200 ms and the display is switched to black. The brightness of the display as a response of the first pulse of the series is below the desired maximum brightness, which can be reproduced several pulses later. In the prior art preset signals are supplied, which preset signals comprise a pulse or a series of pulses with an energy sufficient to release the electrophoretic particle from a static state at one of the two electrodes, but too low too reach the other one of the electrodes. The preset signal reduces the underdrive effect. Because of the reduced underdrive effect the optical response to an identical data signal will be substantially equal, regardless of the history of the display device and in particular its dwell time. The underlying mechanism can be explained because after the display device is switched to a predetermined state e.g. a black state, the electrophoretic particles become in a static state, when a subsequent switching is to the white state, a momentum of the particles is low because their starting speed is close to zero. This results in a long switching time. The application of the preset pulses increases the momentum of the electrophoretic particles and thus shortens the switching time. It is also possible that after the display device is switched to a predetermined state e.g. a black state, the electrophoretic particles are “frozen” by the opposite ions surrounding the particle. When a subsequent switching is to the white state, these opposite ions have to be timely released, which requires additional time. The application of the preset pulses (sometimes also called shaking pulses, since they “shake up” the particles) speeds up the release of the opposite ions thus the de-freezing of the electrophoretic particles and therefore shortens the switching time. The application of the preset pulses increases the momentum of the electrophoretic particles and thus shortens the switching time.

A further advantage is that the application of the preset pulses substantially eliminates a prior history of the electronic ink, whereas in contrast conventional electronic ink display devices requires massive signal processing circuits for the generation of data pulses of a new frame, storage of several previous frames and a large look-up table.

Such a preset pulse can have a duration of one order of magnitude less than the time duration of an image update. An image update is the instance where the image information of the display device is renewed or refreshed.

Application of the preset signals, however, could also lead to so called flicker. The preset signals do have a small effect on the image displayed. In the prior art it is suggested to alter the preset signals between frames. For example, when in a single frame addressing period the preset pulses are applied with a positive polarity to all even rows and a negative polarity to all odd rows adjacent rows of the display device will appear alternately brighter (e.g. the even rows) and darker (e.g. the odd rows) and in the subsequent frame addressing period the positive and negative polarities of the preset pulses are inverted, the odd rows will appear brighter and the even rows will appear darker, as a consequence the temporal perceptual appearance will then hardly be effected, as the eye integrates these subsequent frames (temporal averaging) so that odd and even rows appear to have substantially equal brightness. A temporal smoothing of brightness deviations occurs due to the fact that the preset signals are altered between frames. This principle is similar to the line inversion principle in methods for driving liquid crystal displays with reduced flicker.

Thus by changing the preset signals between frames a temporal averaging may be obtained which improves the image rendition. The application of preset signals has, apart from a positive effect, however also a negative effect, it requires energy and time, and constitutes a restriction on the load and speed of the drivers.

It is an object of the invention to reduce one or more of the aforementioned problems.

To this end the display device in accordance with the invention is characterized in that the control means are arranged to change preset signals between frames in a column-to-column scheme and that the means for supplying preset signals are arranged such that for the preset signals to at least a part of the image screen comprising a group of columns and rows only one set of data is transferred for the preset signals for said group.

The preset signals require a data transfer to the drivers. The inventors have realized that when a scheme is used in which data for application of the preset signals is changed from row to row (row inversion schemes) a vast amount of data is to be transferred for each frame since each preset signal for each row has to be separately addressed and requires transfer of preset signal data. When a column inversion scheme is used, the inventors have realized that it is possible to apply one set of preset signals to the entire group without the need of changing the data on the drivers. All rows in the group can be addressed with preset signals, once a single set of data is provided to the data drivers and it is not needed that the data drivers are provided with further data. This strongly reduces the need for data transfer, the energy and time required. It also offers a possibility to reduce the total frame time, since the transfer of data, including data for preset signals determines amongst others the frame time and thereby the refresh frequency, i.e. number of frames per second. The rows may be addressed one at a time, in the standard manner, or alternatively more than one row could be addressed simultaneously, for example by allowing a plurality of row drivers to run simultaneously.

Preferably the group of columns and rows comprises substantially all display elements.

Within the concept of the invention, the display screen may be divided in a number of groups, for instance two groups, each covering approximately half of the display screen, or 4 groups, each covering a quarter of the screen, or n×m groups, each covering a part of the screen. The groups may be intertwined. In each embodiment the advantage is obtained. However, the smaller the number of groups the larger the effect Preferred are therefore embodiments in which there is only one group (i.e. the group covers all display elements), or a small number of groups, 2, 4 or n×m (where n,m=1,2,3). For large display devices (larger than 15″) it may be advantageous to divide the drivers and divide the display screen in e.g. four quadrants, since this would reduce the lengths of electrodes.

Further advantageous embodiments of the invention are specified in the dependent claims.

In an embodiment the display elements are interconnected in two or more groups whereby preset pulses having a different polarity are supplied to the different parts of the screen. This would reduce within a frame the spatial brightness fluctuations.

Within the concept of the invention a ‘control means for syppling’ and “means for supplying” as well as in general “means for” is to be broadly understood and to comprise e.g. any piece of hard-ware (such a controller, supplier), any circuit or sub-circuit designed for performing a control or a supply of one or more signals as well as any piece of soft-ware (computer program or sub program or set of computer programs, or program code(s)) designed or programmed to perform such an act in accordance with the invention as well as any combination of pieces of hardware and software acting as such, alone-or in combination, without being restricted to the below given exemplary embodiments.

The invention is also embodied in any computer program comprising program code means for performing a method in accordance with the invention when said program is run on a computer as well as in any computer program product comprising program code means stored on a computer readable medium for performing a method in accordance with the invention when said program is run on a computer.

These and other aspects of the invention are apparent from and will be elucidated with reference to the embodiments described hereinafter.

In the drawings:

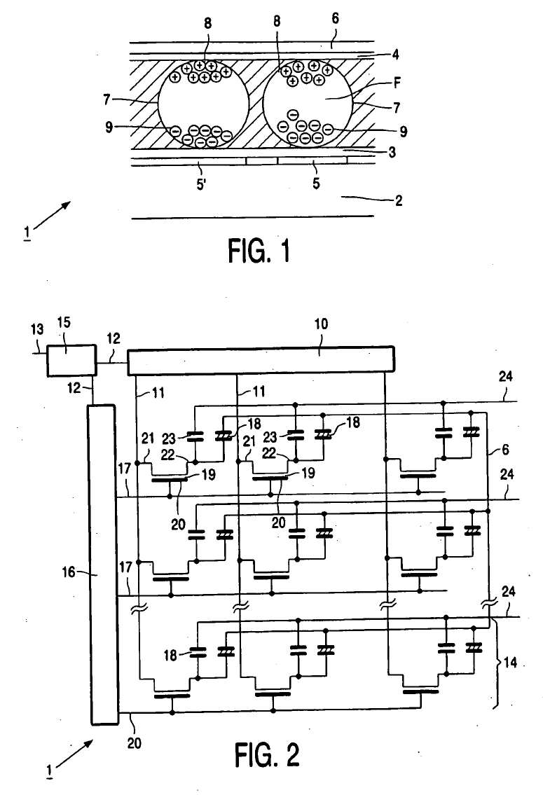

FIG. 1 shows diagrammatically cross-section of a portion of a display device,

FIG. 2 shows diagrammatically an equivalent circuit diagram of a portion of a display device,

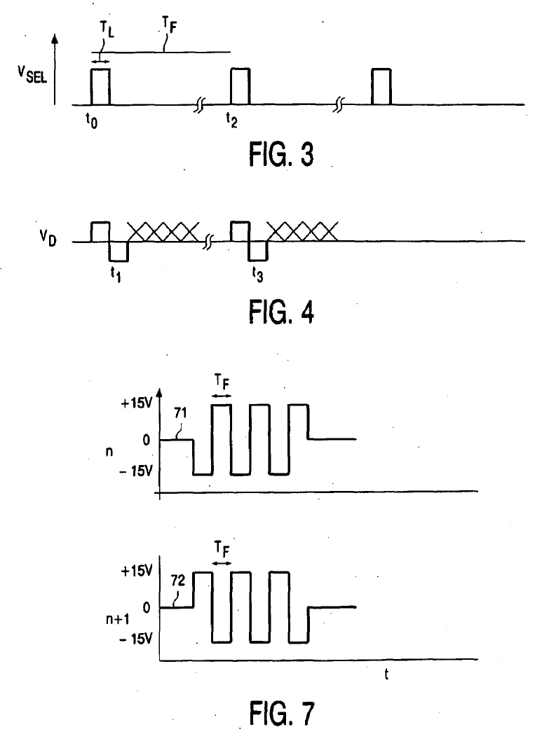

FIGS. 3 and 4 shows drive signals and internal signal of the display device,

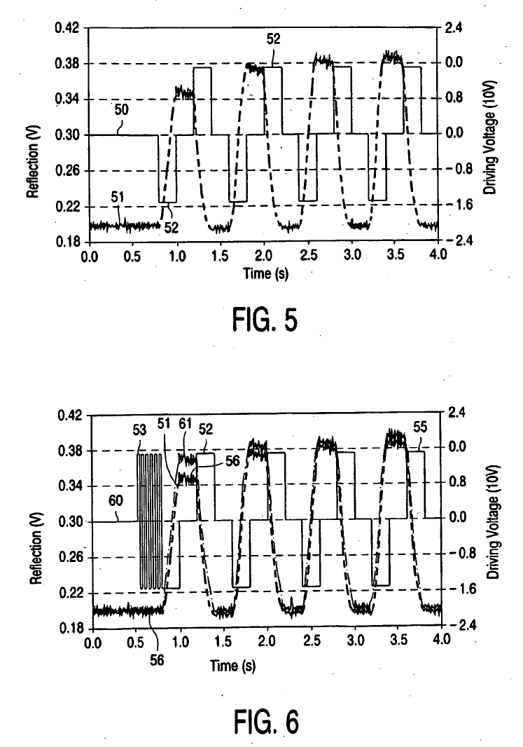

FIG. 5 shows an optical response of a data signal,

FIG. 6 shows an optical response of a preset signal and a data signal

FIG. 7 shows preset signals for pixel electrode for two adjacent rows consisting of 6 pulses of opposite polarities,

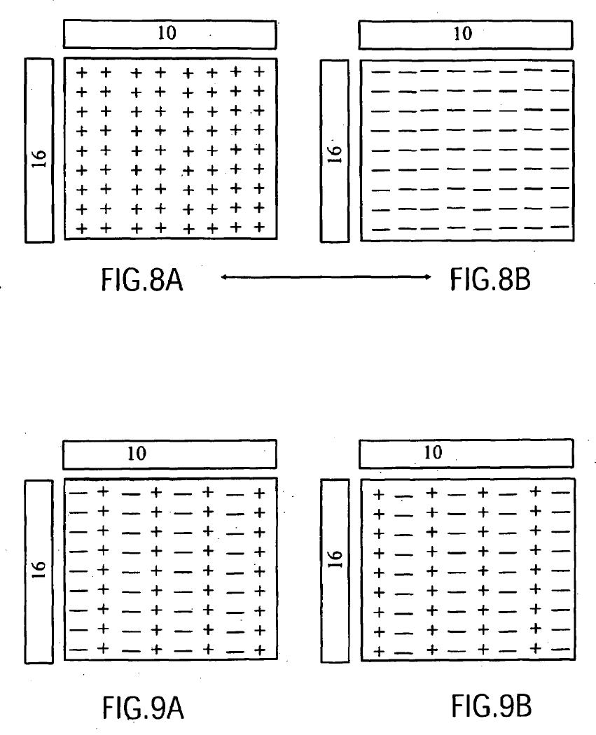

FIG. 8 illustrates a scheme in accordance with the invention,

FIG. 9 illustrates a further scheme in accordance with the invention

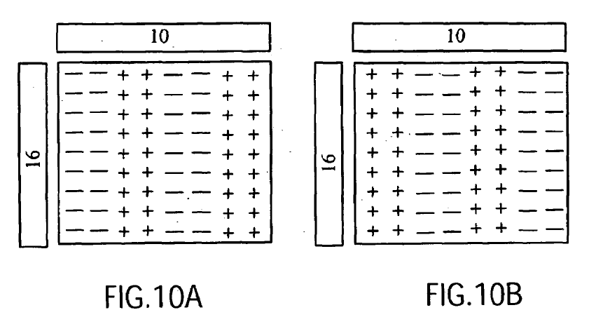

FIG. 10 illustrates yet a further scheme in accordance with the invention.

The Figures are schematic and not drawn to scale, and, in general, like reference numerals refer to like parts.

FIG. 1 diagrammatically shows a cross section of a portion of an electrophoretic display device 1, for example of the size of a few display elements, comprising a base substrate 2, an electrophoretic film with an electronic ink which is present between two transparent substrates 3,4 for example polyethylene, one of the substrates 3 is provided with transparent picture electrodes 5 and the other substrate 4 with a transparent counter electrode 6. The electronic ink comprises multiple micro capsules 7, of about 10 to 50 microns. Each micro capsule 7 comprises positively charged white particles 8 and negative charged black particles 9 suspended in a fluid F. When a positive field is applied to the picture electrode 5, the white particles 8 move to the side of the micro capsule 7 directed to the counter electrode 6 and the display element become visible to a viewer. Simultaneously, the black particles 9 move to the opposite side of the microcapsule 7 where they are hidden to the viewer. By applying a negative field to the picture electrodes 5, the black particles 9 move to the side of the micro capsule 7 directed to the counter electrode 6 and the display element become dark to a viewer (not shown). When the electric field is removed the particles 8, 9 remains in the acquired state and the display exhibits a bi-stable character and consumes substantially no power.

FIG. 2 shows diagrammatically an equivalent circuit of a picture display device 1 comprising an electrophoretic film laminated on a base substrate 2 provided with active switching elements, a row driver 16 and a column driver 10. Preferably, a counter electrode 6 is provided on the film comprising the encapsulated electrophoretic ink, but could be alternatively provided on a base substrate in the case of operation using in-plane electric fields. The display device I is driven by active switching elements, in this example thin film transistors 19. It comprises a matrix of display elements at the area of crossing of row or selection electrodes 17 and column or data electrodes 11. The row driver 16 consecutively selects the row electrodes 17, while a column driver 10 provides a data signal to the column electrode 11. Preferably, a processor 15 firstly processes incoming data 13 into the data signals. Mutual synchronisation between the column driver 10 and the row driver 16 takes place via drive lines 12. Select signals from the row driver 16 select the pixel electrodes 22 via the thin film transistors 19 whose gate electrodes 20 are electrically connected to the row electrodes 17 and the source-electrodes 21 are electrically connected to the column electrodes 11. A data signal present at the column electrode 11 is transferred to the pixel electrode 22 of the display element coupled to the drain electrode via the TFT. In the embodiment, the display device of FIG. 1 also comprises an additional capacitor 23 at the location at each display element 18. In this embodiment, the additional capacitor 23 is connected to one or more storage capacitor lines 24. Instead of TFT other switching elements can be applied such as diodes, MIM's, etc.

FIGS. 3 and 4 show drive signals of a conventional display device. At the instance t0, a row electrode 17 is energized by means of a selection signal Vse1 (FIG. 1.), while simultaneously data signals Vd are supplied to the column electrodes 11. After a line selection time tL has elapsed, a subsequent row electrode 17 is selected at the instant t1, etc. After some time, for example, a field time or frame time, usually 16.7 msec or 20 msec, said row electrode 17 is energized again at instant t2 by means of a selection signal Vse1, while simultaneously the data signals Vd are presented to the column electrode 11, in case of an unchanged picture. After a selection time tL has elapsed, the next row electrode is selected at the instant t3. Because the bistable character of the display device, the electrophoretic particles remains in their selected state and the repetition of data signals can be halted after several frame times when the desired grey level is obtained. Usually, the image update time is several frames.

FIG. 5 shows a first signal 51 representing an optical response of a display element of the display device of FIG. 2 to a data signal 50 comprises pulses of alternating polarity after a dwell period of several seconds. In FIG. 5 the optical response 51 is indicated by ---- and the data signal by ______. Each pulse 52 of the data signal 50 has a duration of 200 ms and a voltage of alternating plus and minus 15 V. FIG. 5 shows that the optical response 51 after the first negative pulse 52 is not a desired grey level, which is obtained only after the third or fourth negative pulse.

In order to improve the accuracy of the desired grey level with the data signal the processor 15 generates a single preset pulse or a series of preset pulses before the data pulses of a next refresh field, where the pulse time is typically 5 to 10 times less than the duration of an image update. In case the duration of an image update is 200 ms, the duration of a preset pulse is typically 20 ms.

FIG. 6 shows the optical response to a data signal 60 of the display device of FIG. 2 as a response to a series of 12 preset pulses of short duration and data pulses of 200 ms having a voltage of alternating polarity of plus and minus 15 V. In FIG. 6 the optical response 51 is indicated by ----, the improved optical response 61 by -.-.-.-.- and the data signal by ______. The series of preset pulses consists of 12 pulses of alternating polarity. The voltage of each pulse is plus or minus 15 V. FIG. 6 shows an significant increase of the grey scale accuracy, the optical response 61 is substantially at an equal level as the optical response after the fourth data pulse 55. However, some flicker may become visible introduced by the preset pulses, see optical response 56. In order to reduce the visibility of this flicker, the processor 15 and the row driver 16 can be arranged such that the row electrodes 17 associated with display elements are interconnected in two groups, and the processor 15 and the column driver 10 are arranged for executing an inversion scheme by generating a first preset signal having a first phase to the first group of display elements and a second preset signal having a second phase to the second group of display element, whereby the second phase is opposite to the first phase. Alternatively, multiple groups can be defined, whereto reset pulses are supplied with different phases. For example, the row electrodes 17 can be interconnected in two groups one of the even rows and one group of the odd row whereby the processor generates a first preset signal consisting of six preset pulses of alternating polarity of plus and minus 15 V starting with a negative pulse to the display elements of the even rows and a second preset signal consists of six preset pulses of alternating polarity of plus and minus 15 V starting with a positive pulse to display elements of the odd rows.

FIG. 7 shows two graphs indicative for an inversion scheme. A first graph 71 relates to a first preset signal consisting of 6 preset pulses of 20 ms supplied to a display element of an even row n and a second graph 72 related to a second preset signal consisting of 6 preset pulses of 20 ms supplied to a display element of an odd row n+1, whereby the phase of the second preset signal is opposite the phase of the first preset signal. The voltage of the pulse is alternating between plus and minus 15 V. The first preset signal may be denoted by a plus sign (+), the second by a minus sign (−).

Instead of the series of preset pulses applied to two or more different groups of rows, the display elements can be divided in two groups of columns, for example, one group of even columns and one group of odd columns whereby the processor 15 executes an inversion scheme by generating a first preset signal consisting of six preset pulses of alternating polarity of plus and minus 15 V starting with a negative pulse to the display elements of the even columns and a second preset signal consists of six preset pulses of alternating polarity of plus and minus 15 V starting with a positive pulse to the display elements of the odd columns. The above figures and explanation can also be found in the cited document WO 03/79324. The spatial inversion scheme (i.e. providing opposite signals to different groups e.g. odd and even rows) provides for a reduction of spatial flicker. It is also remarked in WO 03/79324 that a temporal inversion scheme may be used in which in subsequent frames the polarity of the preset signals is reversed. Such altering of the preset signals (polarity inversion) leads to a temporal smoothing of brightness differences.

Whilst the above would result in the required flicker reduction, it would require a high rate of data transfer (e.g. from a memory/look-up-table) to the drivers, and a fast loading of the drivers. These will result in an increase in power consumption. In addition, the inventors have realized that there are systems related problems if a shorter frame time is required. One of the major limitations is the time required to load the data from the memory/look-up-table onto the data drivers before it is driven onto all the pixels of the row being addressed.

Transferring data usually requires several clock periods. Even using parallel processing for a device having 800 columns and 600 rows, it was found that around 200 clock periods were required to load all the data for the 800 columns onto the data drivers. As the minimum clock period is 60 nsec, this results in at least a 12 microsecond line time. When a row inversion scheme of n rows (i.e. inversion of signals within a frame is done in a row-to-row scheme) is used it nominally requires n line periods to transfer all data, making it impossible to reduce the frame time below 600 rows×12 microseconds=7.2 msec. With additional time required for actually transferring the information, the shortest frame time becomes around 8 msec.

In the invention a time-reduced flicker shaking is provided by applying a column inversion approach. In a column inversion approach the sign of the preset signals is the same along a column, and is only altered between frames. The inventors have realized that applying a column inversion scheme substantially shorter frame times are possible, since they have realized that it is possible to send information from the data drivers to the entire image (i.e. all rows) to be shaken (i.e. to be provided with preset signals) without changing the data voltages present on the drivers. For example, during a shaking operation, the odd numbered rows of the image may be addressed with a positive data voltage and the even numbered rows of the image may be addressed with a negative data voltage during one frame; whilst the even numbered rows of the image may be addressed with a positive data voltage and the odd numbered rows of the image may be addressed with a negative data voltage during a following frame.

At the start of the first frame the data drivers are loaded with the alternating positive/negative voltage data for the column inversion for the first frame. This operation will require the usual row time (12 microseconds in the above example) and could precede the start of the frame if an entire image is being addressed in this manner (for example in the blanking time between 2 frames). At this point, the first row is addressed. This addressing period may now be shorter than the usual row time, and will in practice only be limited by either the charging time of the pixel through the addressing transistors, or by RC delay times along rows or columns. Both of these limitations can be reduced by technological choices (size of addressing TFT: pixel capacitance/storage capacitance: resistance of row/column metals etc) whereby an addressing time close to 1 microsecond could be feasible. Subsequently, the remaining rows in the display are addressed without the data drivers being provided with further data. All subsequent rows receive the same data, whereby a column inverted image is realized. In this case, all subsequent rows can be addressed with the shorter addressing period (say 1 microsecond). In addition, no extra time will be required for transferring data from the memories to the data drivers. In this manner, a frame time of around 1 msec will be feasible.

Before the start of the following frame, data of the opposite polarity is loaded into the data drivers in the usual manner, and the rows of the new frame are addressed as above.

In this manner it is possible to reduce the frame rate to 5 msec or lower, and apply alternating shaking voltages to adjacent columns in the display, and increase the flicker frequency to 100 Hz or higher, whereby the flicker would be removed.

In addition to the advantages of lower optical flicker, this embodiment has the advantage of lower power as there is no data transfer between memory/look-up-table and data drivers required after first data loaded onto driver and in addition that the data drivers do not need to continue clocking after first data is loaded.

FIGS. 8 to 10 illustrate various embodiments of the invention. In each figure a plus-sign stands for a preset signal of any form and a minus-sign stands for the inverse preset signal. In FIG. 8 all columns are given the same preset signal in frame A, and the opposite signal in frame B. This will leads to a temporal flicker reduction. In FIG. 9 a spatial inversion scheme is added. In each frame, for adjacent columns the preset signals have opposite signs. This provides for spatial flicker reduction. In FIG. 10 in each frame n columns (in this example n=2, but may be any number) receive preset signals of the same sign.

For large display devices it may be advantageous to provide a plurality of the drivers and divide the display screen in e.g. four quadrants. In this case, it would be possible to apply the embodiments described above to only one or a to a subset of the divided areas of the display, or to apply different embodiments to different subsets of the divided areas. Diving the image screen into quadrants is a most preferred embodiment. This reduces the length of the electrodes very efficiently.

It is remarked that in the above example use is made of inversion of the sign of the preset signal. Throughout the specification the word “inversion” is often used. The invention is, although simple inversion schemes are preferred embodiments due to their simplicity, not restricted to such embodiments. The idea behind the invention is that it is possible to use different preset signals, wherein the preset signal is altered between frames, and using a column-to-column scheme it is possible to do so by transferring one, limited, set of data for each frame. In the example the preset signals differ in sign, which is an easy way of generating different signals. However, the preset signals may differ in other aspects, for instance in length, in amplitude or in number of sub-pulses.

It will be obvious that many variations are possible within the scope of the invention without departing from the scope of the appended claims.

The invention is also embodied in a method for driving a display device (1) comprising electrophoretic particles (8,9), an image screen comprising an array of display elements comprising a pixel electrode and a second electrode between which a portion of the electrophoretic particles are present, and control means (15) for supplying drive signals to the electrodes to bring display elements in a predetermined optical state corresponding to the image information to be displayed, wherein in operation the image is displayed in subsequent frames, said control means comprising a row driver and a column driver, and means for supplying preset signals (53) to the display elements whereby the preset signals applied to display elements alter between subsequent frames, wherein the control means are arranged to change preset signals between frames in a column-to-column scheme and that the means for supplying preset signals are arranged such that for the preset signals to at least a part of the image screen comprising a group of columns and rows only one set of data is transferred for the preset signals for said group.

Furthermore the invention is embodied in a computer program product comprising program code means stored on a computer readable medium for use in a method in accordance with the invention when said program is run on a computer.

It will be appreciated by persons skilled in the art that the present invention is not limited by what has been particularly shown and described hereinabove. The invention resides in each and every novel characteristic feature and each and every combination of characteristic features. Reference numerals in the claims do not limit their protective scope. Use of the verb “to comprise” and its conjugations does not exclude the presence of elements other than those stated in the claims. Use of the article “a” or “an” preceding an element does not exclude the presence of a plurality of such elements.

The present invention has been described in terms of specific embodiments, which are illustrative of the invention and not to be construed as limiting. The invention may be implemented in hardware, firmware or software, or in a combination of them. Other embodiments are within the scope of the following claims.

1. A display device (1) comprising electrophoretic particles (8,9), an image screen comprising an array of display elements comprising a pixel electrode and a second electrode between which a portion of the electrophoretic particles are present, and control means (15) for supplying drive signals to the electrodes to bring display elements in a predetermined optical state corresponding to the image information to be displayed, wherein in operation the image is displayed in subsequent frames, said control means comprising a row driver (16) and a column driver (10), and means for supplying preset signals (53) to the display elements whereby the preset signals applied to-display elements alter between subsequent frames, wherein the control means are arranged to change preset signals between frames in a column-to-column scheme and that the means for supplying preset signals are arranged such that for the preset signals to at least a part of the image screen comprising a group of columns and rows only one set of data is transferred for the preset signals for said group.

2. A display device as claimed in claim 1, wherein the group comprises at least two columns.

3. A display device as claimed in claim 1, wherein display screen is composed of n×m groups of columns and rows.

4. A display device as claimed in claim 2, wherein the display screen is composed of two groups of columns and rows.

5. A display device as claimed in claim 1, wherein the group comprises substantially all columns and rows-of the image screen.

6. A display device as claimed in claim 3, wherein the display screen is divided in quadrants, to each quadrant a group is associated with its row and column driver.

7. A method for driving a display device (1) comprising electrophoretic particles (8,9), an image screen comprising an array of display elements comprising a pixel electrode and a second electrode between which a portion of the electrophoretic particles are present, and control means (15) for supplying drive signals to the electrodes to bring display elements in a predetermined optical state corresponding to the image information to be displayed, wherein in operation the image is displayed in subsequent frames, said control means comprising a row driver and a column driver, and means for supplying preset signals (53) to the display elements whereby the preset signals applied to display elements alter between subsequent frames, wherein the control means are arranged to change preset signals between frames in a column-to-column scheme and that the means for supplying preset signals are arranged such that for the preset signals to at least a part of the image screen comprising a group of columns and rows only one set of data is transferred for the preset signals for said group.
